(19) United States
(12) Patent Application Publication
(10) Pub. No.: US 2007/0107696 A1
(43) Pub. Date: May 17, 2007

(54) Two-stage distribution device of actuating fluid for hydraulically driven pump-injector for internal combustion engines

(76) Inventor: Boris Feinleib, Jerusalem (IL)

Correspondence Address: NATH & ASSOCIATES, 112 South West Street, Alexandria, VA, 22314, US

(21) Appl. No.: 11/587,949

(22) PCT Filed: Feb. 25, 2004
(86) PCT No.: PCT/IL04/00185

§ 371 Date: Oct. 27, 2006

(51) Int. Cl. F02M 57/02

(52) U.S. Cl. 123/446

(57) ABSTRACT

A two-stage distribution device of actuating fluid for hydraulically driven pump-injector for internal combustion engines, comprising two stages of control of the distribution of the actuating fluid, a first stage valve (1) controls a second stage valve (8) which controls distribution of actuating fluid to a power piston (37) of the stage pressure intensifier.

### TECHNICAL FIELD

Present invention relates to the field of internal combustion engines, specifically to diesels and, more specifically, to their hydraulically driven pump-injectors. The proposed distribution device can also be used in other equipment where cyclic delivery of actuating fluid to actuating mechanism is required.

### BACKGROUND ART

A comprehensive technical solution allowing for increasing fuel efficiency and durability, while decreasing noise and especially emission levels in the entire operational envelope of the engine requires a considerable increase in injection pressure (up to 2500 bar) and flexible control of the injection characteristic (2-phase and multiphase injection, and “rate shape”). This problem cannot be efficiently solved by conventional fuel systems with power piston driven by a cam mechanism, whose frequency is directly linked to the rotational speed of the engine's crankshaft that varies in the course of its operation. This does not allow for optimizing injection parameters in a wide range of operating modes.

Modem diesel engines require a highly sophisticated Fuel Injection System (FIS) delivering an ultra high injection pressure, while maintaining split injections per shot with full flexibility and decoupled from engine's speed and load. Hydraulically driven and electronically controlled pump-injectors with pressure intensification allow for achieving said parameters throughout the entire engine's operational envelope.

For controlling the operation of a hydraulically driven pump-injector, a distribution device is used which enables cyclic delivery of the actuating fluid to the power piston of the pressure intensifier and subsequent removal of the exhaust fluid from the above-piston cavity after the end of the working stroke of the power piston and pumping plunger.

In relatively small cylinder displacement diesel engines with relatively low volume fuel delivery, the injection of fuel can be controlled by a distribution device with a single control stage, for instance, a slide or conical valve with electromagnetic or another type of drive.

In high-power diesels, used, for instance, in locomotives, off road heavy vehicles, marine applications, and stationary power generation systems, a one-stage distribution device cannot ensure the sufficient flow of the fuel delivered to the hydraulically driven pump-injectors. In hydraulically driven pump-injectors of this class the actuating fluid must be supplied at high rate (up to 1.5×10⁴ cm³/s). Therefore, even when the speed of the actuating fluid does not exceed 50 m/s (in order to avoid significant losses of the fluid pressure and thus decrease of the pump-injector efficiency), the open-flow cross sectional area of the valve of the distribution device must be at least 3 cm². Such open-flow cross sectional area cannot be practically achieved in a one-stage electronically controlled distribution device of acceptable dimensions and reasonable power consumption of the valve drive. In addition, it is extremely difficult to obtain “rate shape” in a one-stage distributing device. Therefore, in pump-injectors for high-power diesels, two-stage distributing devices must be used, comprising the first stage made as slide, conical or spherical valve with relatively small open-flow cross sectional area and having electromagnetic or another type of drive, and the second stage, having a hydraulic drive controlled by the first stage and thus controlling the supply of the actuating fluid to the above-piston cavity of the power piston of the pressure intensifier.

Two-stage distribution device allows for achieving large open-flow cross sectional areas through which the actuating fluid from the accumulator (rail) is introduced into the working cavity of the power piston allowing at the same time for acceptable dimensions of the device and relatively low power consumption for the valve drive of the distribution device. The design of such a distribution device is the subject of the present invention.

### DISCLOSURE OF INVENTION

One of the main design characteristics of the two-stage distribution device according to the invention is that the operation of the second-stage valve (i.e. achieving its reciprocating motion), which in turn controls the operation of the power piston, is controlled by pushrods whose ends are set against the valve ends and whose diameters are considerably smaller than the diameter of the second stage valve. The pushrods have different diameters, and the working cavity of the pushrod of the larger diameter is connected by a channel to the first stage of the distributing device. Controlling the valve by pushrods allows for increasing the diameter and, consequently, the open-flow cross sectional area of the second stage valve so as to allow the required supply to the power pistons and at the same time to decrease the required carrying capacity and power consumption of the electronically controlled valve of the first stage, which in turn controls the operation of said pushrods. All this significantly decreases the dimensions of the distribution device and reduces the power consumption of the first stage drive.

In the distribution device in accordance with the invention, two-way valves with conical or spherical sealing surfaces (although slide valves are also possible) in both first and second stages should be preferably used. In conical or spherical valves, compared to slide valves, it seems to be easier to ensure reliable sealing of the working cavities. However, in two-way valves with conical or spherical seat surfaces, good coaxiality between said surfaces and seats of the bearing elements of the device must be provided, in order to facilitate the sealing of the working cavities of valves and pushrods when sealing surfaces of the valve contact said seats. In order to solve this problem, in the distribution device in accordance with the invention the valves are made of one piece or composite and consist of two parts—main section and tail section, divided by a cylindrical protrusion on which sealing conical or spherical surfaces are located concentrically with the valve axis and facing each other, said cylindrical protrusion being disposed in the distributing cavity formed in the valve body, the main section being centered and moving in the body orifice, in which one of the seats is formed, and the tail section moving inside a bushing in which the second bearing edge is formed, said bushing being centered with said tail section of the valve and being freely mounted in said valve body.

The distribution device in accordance with the invention allows for controlling the injection characteristics (“rate shape”). To achieve this, the larger-diameter pushrod has a groove and communicates via a channel with the drain cavity, said channel having a jet, and the groove being disposed in such a way that at a given moment of the initial phase of the working stroke of the pushrod with the second stage valve, it is connected with said working cavity of the pushrod.

### SUMMARY OF THE INVENTION

Summary of the invention is provided with regard to hydraulically driven fuel pump-injectors for diesel engines.

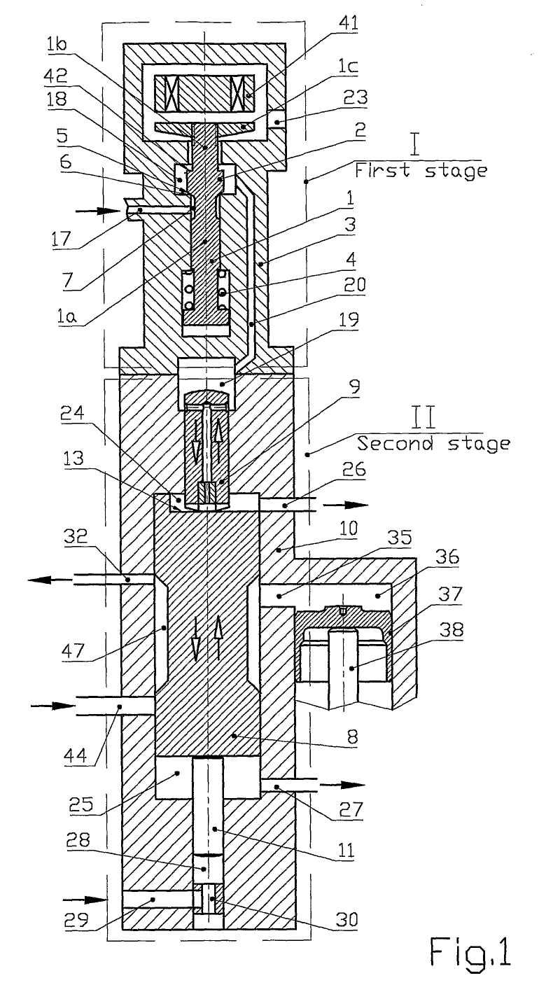

In FIGS. 1, 2, 3, 4, 5, several embodiments of the invention are shown.

FIG. 1 shows an embodiment of a distribution device with a conical (spherical) two-way valve in the first stage and a cylindrical slide valve in the second stage.

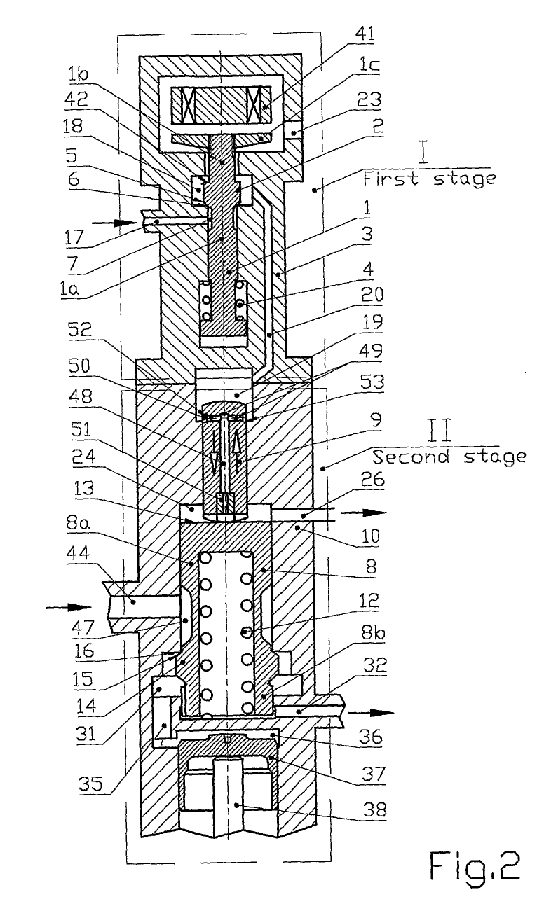

FIG. 2 shows an embodiment of a distribution device with conical (spherical) two-way valves in both first and second stages

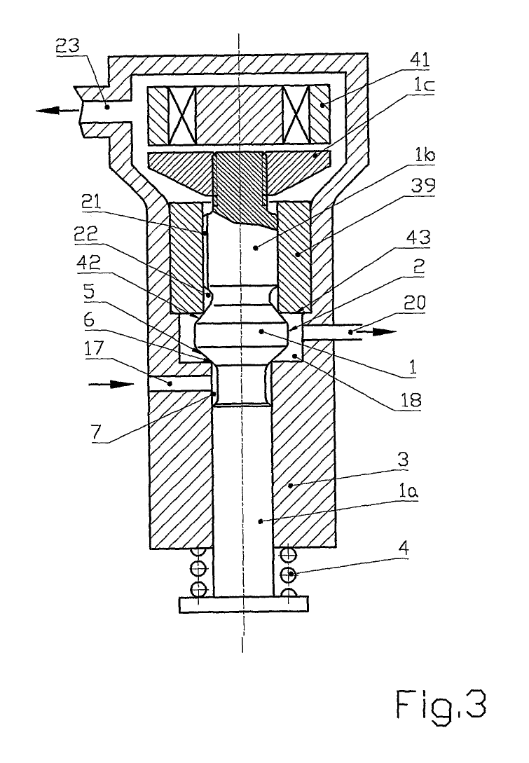

FIG. 3 shows a detailed diagram of a conical (spherical) two-way valve of the first stage.

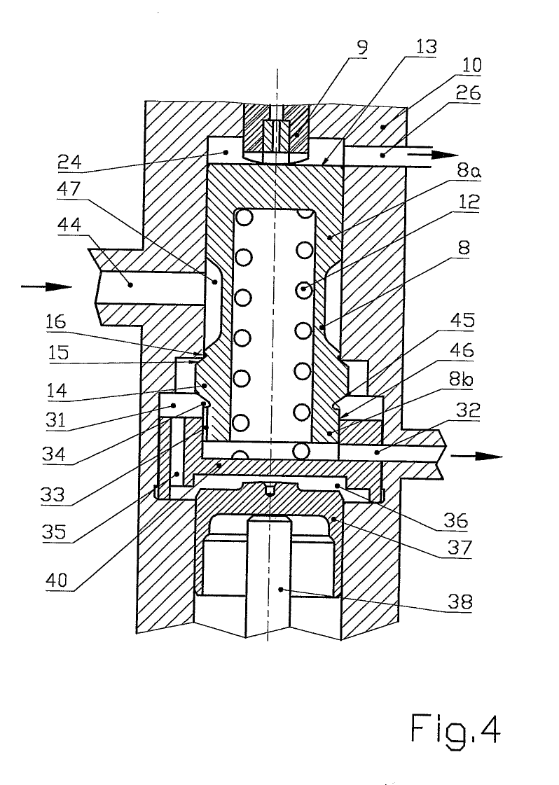

FIG. 4 shows a detailed diagram of a conical (spherical) two-way valve of the second stage.

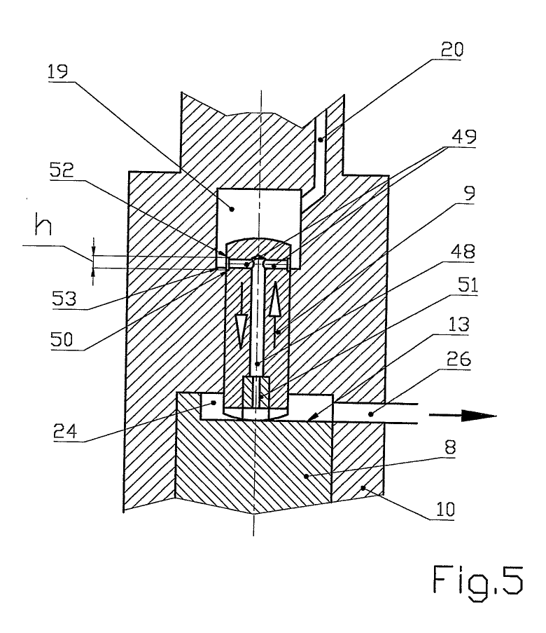

FIG. 5 shows a detailed diagram of the larger-diameter pushrod of the second stage valve.

In FIGS. 1, 2, 3, 4, and 5:

1—first stage valve; 1a—main section of the first stage valve; 1b—tail section of the first stage valve; 1c—disk-like extension on the first stage valve (armature of the electromagnet); 2—cylindrical protrusion of the first stage valve; 3—body of the first stage; 4—return spring of the first stage valve; 5—first sealing surface of protrusion 2 of the first stage valve; 6—sealing annular seat of body 3 in the first stage; 7—groove (cavity) on the first stage valve; 8—second stage valve; 8a—main section of the second stage valve; 8b—tail section of the second stage valve; 9—larger-diameter pushrod causing valve 8 to perform a working stroke; 10—body of the second stage valve; 11—smaller-diameter pushrod causing valve 8 to perform a return stroke; 12—return spring of the second stage valve (FIGS. 2, 4); 13—end of valve 8; 14—cylindrical protrusion on valve 8; 15—the first sealing surface of protrusion 14 of valve 8; 16—bearing edge in body 10 of valve 8; 17—channel through which actuating fluid is fed into groove 7 of valve 1; 18—distributing cavity of the valve of the first stage; 19—working cavity of pushrod 9; 20—channel through which the distributing cavity of valve 1 is communicating with the working cavity of pushrod 9; 21—channels, through which distributing cavity 18 of the first stage is communicating with groove 22 of valve 1; 22—groove of valve 1, through which the actuating fluid is introduced via channels 21 to channel 23 connected to the drain tank; 23—channel in body 3 connected to the drain tank; 24—drain cavity of the lower end of pushrod 9; 25—drain cavity of the upper end of pushrod 11; 26—channel connecting drain cavity 24 of pushrod 9 with the drain tank; 27—channel connecting drain cavity 25 of pushrod 11 with the drain tank; 28—working cavity of the smaller-diameter pushrod 11; 29—channel connecting the working cavity 28 of pushrod 11 via jet 30 with the source of the actuating fluid (accumulator); 30—jet; 31—distributing cavity of valve 8 of the second stage; 32—drain channel in body 10, connecting the distributing cavity 31 of valve 8 with the drain tank; 33—channels in tail section 8a of valve 8, through which the exhausted actuating fluid is introduced from distributing cavity 31 via groove 34 to the drain channel 32; 34—annular groove in tail section 8c of valve 8, connecting distributing cavity 31 with channels 33; 35—channel connecting distributing cavity 31 of valve 8 with the working cavity 36 of power piston 37; 36—working cavity of power piston 37; 37—power piston; 38—pumping plunger; 39—bushing, in which tail section 1b of the first stage valve is disposed; 40—bushing, in which tail section 8b of the second stage valve is disposed; 41—electromagnet of the valve of the first stage; 42—the second sealing surface of the first stage valve; 43—annular sealing bearing edge of bushing 39 of the first stage valve; 44—channel through which distributing cavity 31 of the second stage is connected with the source of the actuating fluid (accumulator) when slide valve 8 is in the extreme lower position (see FIG. 1, 2 and 4); 45—the second sealing surface on protrusion 14 of valve 8; 46—annular sealing bearing edge on bushing 40 of the second stage (FIG. 4); 47—groove (cavity) on valve 8 of the second stage; 48—axial channel of pushrod 9, connecting radial channels 49 with jet 51 (here and below in FIG. 5); 49—radial channels of pushrod 9, connecting groove 50 with axial channel 48; 50—annular groove of pushrod 9, connecting radial channels 49 with working cavity 19 of pushrod 9; 51—jet, through which actuating fluid is introduced from axial channel 48 into drain cavity 24 of pushrod 9; 52—upper edge of groove 50; 53—lower end of the drain cavity 19 of pushrod 9.

Distribution device in accordance with the invention operates as follows (see FIGS. 1, 2, 3, 4, and 5). Between the working strokes (in the dwell position), valve 1 (FIGS. 1, 2, and 3), having main section 1a and tail section 1b separated by cylindrical protrusion 2 and disk-like extension 1c, serving as the armature of electromagnetic drive of the first stage valve, installed in body 3, is moved to the extreme lower position by spring 4. At the same time conical or spherical sealing surface 5 of protrusion 2 of the valve is set against the sealing bearing annular edge 6 of body 3, and seals cavity (groove) 7 formed in valve 1. In the same dwell period, slide valve 8 (FIG. 1 or FIG. 2, if conical or spherical valve is used), with the larger-diameter pushrod 9 disposed in body 10, is moved into the extreme upper position by the smaller-diameter pushrod 11 (FIG. 1) or return spring 12 (FIGS. 2 and 4). In case of a slide valve (FIG. 1), it rests against body 10 with its end 13, and in case of a conical (spherical) valve (FIG. 4), sealing surface 15 of protrusion 14 of valve 8 is pressed to sealing annular bearing edge 16 formed in body 10 of valve 8. At the same time, the actuating fluid through channel 17 (FIG. 3) is introduced into said annular groove 7 of valve 1, distributing cavity 18 of the first stage and working cavity 19 of pushrod 9 formed in body 10 near the upper end of pushrod 9 and connected with distributing cavity 18 by channel 20 (FIGS. 1 and 2) are connected via channels 21 and groove 22 (FIG. 3) of valve 1 and channel 23 in body 3 with the drain tank. At the same time, in the second stage (FIG. 1) of the distribution device formed in body 10, drain cavity 24 near the lower end of pushrod 9 and drain cavity 25 near the upper end of pushrod 11, respectively, are connected via channels 26 and 27 with the drain tank, and working cavity 28 of the smaller-diameter pushrod 11 is constantly connected with the source of the actuating fluid (accumulator) via channel 29 and jet 30.

In addition, in the dwelling period (FIG. 1), annular groove 47 of valve 8, bounded by the groove formed on valve 8, and body 10, is connected via channel 32 with the drain tank. In the case of a conical (spherical) valve (FIGS. 2, 4), distributing cavity 31 is connected with the drain tank via channels 33 and annular groove 34 of tail section 8b of valve 8; it is also constantly connected with the drain tank via channel 32 in body 10, and via channel 35 with working cavity 36 of power piston 37 driving pumping plunger 38. At the same time, annular groove 47 on valve 8 is constantly connected via channel 44 with the accumulator of the actuating fluid.

The design of the distribution device in accordance with the invention is characterized by the fact that conical (spherical) valve 1 (of the first stage) and valve 8 (of the second stage, FIGS. 2, 3, and 4) are centered and move, respectively, in bushings 39 and 40 (FIGS. 3, 4), with which they form precision-built pairs. Bushings 39 and 40 are freely mounted in bodies 3 and 10, respectively. When electromagnet 41 is energized, the extended disk section 1c of the valve that serves as an armature, is pulled towards the electromagnet, valve 1 due to the electromagnet attraction overcomes the force of spring 4 and travels into extreme upper position, the second sealing surface 42 (FIG. 3) facing sealing surface 5 of said protrusion 2 is pressed to the annular sealing bearing edge 43 of said bushing 39, and distributing cavity 18 is disconnected from the drain tank. At the same time, the actuating fluid from groove 7 connected by channel 17 with the source of the actuating fluid (accumulator) is introduced into distributing cavity 18 of the first stage valve, and into working cavity 19 of pushrod 9, via the slot formed between surface 5 and bearing edge 6. Moved by the pressure of the actuating fluid, pushrod 9 with valve 8 overcomes the force of pushrod 11 (FIG. 1) or spring 12 (FIG. 2) and travels into extreme lower position. At the same time, distributing cavity 31 of valve 8 is disconnected from drain channel 32 (FIGS. 2 and 4) and is connected via channel 44 (in case of a slide valve) with the source (accumulator) of the actuating fluid, which is introduced into working cavity 36 of power piston 37 through channel 35.

If a conical (spherical) valve is used in the second stage (FIGS. 2 and 4), then during the travel of valve 8 downward, the second sealing surface 45 disposed on protrusion 15 facing the first surface 14, is set against the annular sealing bearing edge 46 formed in bushing 40, and disconnects distributing cavity 31 from drain channel 32. At the same time the actuating fluid from the accumulator via channel 44 (FIGS. 2 and 4) is introduced via the slot formed between bearing edge 16 of body 10 and sealing surface 14 of valve 8 into groove 47 of the valve, and then into distributing cavity 31 of the second stage and further via channel 35 into working cavity 36 of power piston 37 that moves pumping plunger 38, evacuating the fuel via a sprayer unit into the engine's cylinder head (when the distribution device is used in hydraulically driven pump-injectors).

When electromagnet 41 of the first stage valve is de-energized, valve 1 (FIG. 3) moved by spring 4 travels into the extreme lower position, and sealing surface 5 of valve 1 is set against bearing annular edge 6 of body 3. At this time, distributing cavity 18 of valve 1, and consequently also working cavity 19 of pushrod 9 are disconnected from cavity 7 (and consequently also from the accumulator) and are connected via the slot formed between the second sealing surface 42 of valve 1 and bearing edge 43 of bushing 39, and also via channels 21, annular groove 22 and channel 23 with the drain tank. Due to the pressure drop in working cavity 19, valve 8 forced by pushrod 11 (in case of a slide valve as shown in FIG. 1) or moved by the spring (when conical or spherical valve is used for the second stage as shown in FIGS. 2 and 4), returns into extreme upper position, ending the working cycle in the device.

If the distribution device in accordance with the invention is predominantly used in hydraulically driven pump-injectors with pressure intensifier, the cyclic fuel delivery is controlled by the time that valve 1 stays in the open extreme upper position, which in turn is controlled by the duration of the electrical signal fed to the electromagnet of valve 1. In order to use the distribution device in accordance with the invention more efficiently, we must control the speed of pushrod 9 in the initial phase of the working stroke of pushrod 9 with valve 8 of the second stage, which allows for changing the rate of the introduction of the actuating fluid into working cavity 36 of power piston 37, and thus helps decrease the rate of the pressure increase in the initial stage of the injection (i.e., achieve the “rate shape”), and, as mentioned above, helps increase the engines' durability and life, lower its noise and decrease the formation of the toxic nitric oxides in the exhaust gases.

To achieve this (see FIG. 5), in pushrod 9, axial 48 and radial 49 channels and groove 50 are made, and also jet 51, through which working cavity 19 of pushrod 9 in the beginning phase of its working stroke is connected with drain cavity 24 of pushrod 9. At the same time, said groove 50 is made in such a way that its upper edge 52 is disposed above the lower end 53 of cavity 19 by the a given value “h” when pushrod 9 is in extreme upper position.

As a result, in the beginning of the pushrod's motion, working cavity 19 of pushrod 9 will be connected with the drain cavity 24 via jet 51, decreasing the speed of the pushrod moved by the actuating fluid flowing into cavity 19 through channel 20.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respect as illustrative and not restrictive, the scope of the invention being indicated by the appended claims rather than by the foregoing description, and all changes which come within the meaning and range of equivalency of the claims are therefore intended to be embraced therein.

### BEST MODE FOR CARRYING OUT THE INVENTION

In the proposed distributing device, slide (FIG. 1) or conical (spherical) valves (FIGS. 1, 2, 3, and 4) can be used in both first and second control stages. However, in the preferred embodiment, two-way conical or spherical valves (FIGS. 2, 3 and 4) should be used both in the first and in the second stages.

When such a valve is used in the first stage, it seems to be feasible to considerably decrease the stroke of the valve (to 0.08-0.15 mm); this simplifies the design and decreases the dimensions of electromagnet or other valve drives, allowing for reducing the actuation time and improving the response and control of the distribution device, especially when it is used for controlling fast (cyclic) actuating mechanisms, for example, for controlling the operation of the pressure intensifier in hydraulically driven pump-injectors.

When using a two-way conical (spherical) valve in the second stage of the distributing device, leakage of the actuating fluid in the closed position of the valve considerably decreases, because the sealing is achieved by tight gapless contact of its sealing surface with the annular bearing edge of the body. When a slide valve is used, the sealing is achieved along the small length of the annular slot formed at the two joining cylindrical surfaces (of the valve and of the body) and through which the actuating fluid from the accumulator is constantly flowing into the drain cavity (even if the valve is connected to the body as a precision pair). Increased leakage of the actuating fluid requires the use of a supply system of the pressure intensifier of large-capacity pumps, which increases the cost of the system and decreases its efficiency.

In order to facilitate the assembling of the valve, the disk-like extension (the armature of the electromagnet 1c in FIG. 3) is made as a separate unit and is fixed to the tail section of the valve by a thread or another joint. In order to ensure the concentricity between the conical bearing surface of said disk 1c and the tail section of valve 1b, these sections must be processed together after connecting said disk to said tail section.

As mentioned above, the distribution device in accordance with the invention can be disposed in an autonomous body or in the body of the actuating mechanism. If the distribution device is used for controlling the operation of the pressure intensifier of hydraulically driven pump-injectors, it is advisable to dispose the second stage directly in the body of the pump-injector, because it allows for reducing the dimensions of the pump-injectors, facilitates their installation in the cylinder head, and shortens the distances connecting the distribution device with the pump-injector. All this increases the reliability of pump-injectors and improves control of the injection process.

The proposed distribution device can operate without jet 51 and channels 48 and 49 (FIG. 5). This leads to increased speeds of the second stage valve during the working stroke and in case of hydraulically driven pump-injectors it leads to a sharp increase in the pressure in the beginning phase of injection. If we install said jet 51 and channels 48 and 49 (FIG. 5), the speed of the second stage valve during the working stroke will decrease, and when the distribution device is used in hydraulically driven pump-injectors, the speed of the travel of the power piston with the pumping plunger in the beginning phase of the injection will also decrease, as well as the pressure rise in the forefront of the injection characteristic. As a result, we will achieve the “rate shape” which is required, as mentioned above, for increasing the diesel's life, decreasing noise and reducing emission levels.

The control of the forefront injection characteristic can be further improved if we make groove 50 and channels 48 and 49 in pushrod 9 (FIG. 5) in such a way that the actuating fluid from working cavity 19 of pushrod 9 will flow only during some part of the working stroke of pushrod 9 with the second stage valve 8, and thus control the duration of the low-intensity phase of the travel of pushrod 9 with valve 8 and better adapt the distributing device, and consequently the pump-injector to the requirements of a specific engine.

### INDUSTRIAL APPLICABILITY

The proposed distribution device is designed primarily for use in hydraulically driven pump-injectors with pressure intensifier. However, the distribution device in accordance with the invention can also be used in other mechanisms and machines where cyclic delivery of the actuating fluid to the actuating mechanism is required. Preferably, two-way distribution device of the actuating fluid should be used in hydraulically driven pump-injectors for diesels with relatively high volume fuel deliveries used for example in heavy off roads and other vehicles, locomotives, marine applications, and as stationary power generators.

In pump-injectors for such diesels, the actuating fluid must be supplied to the power piston of the pressure intensifier at high volume rate, achievable only when a two-stage distribution device is used that represents the subject of the present invention.

I claim:

1. Hydromechanical device for distributing the actuating fluid (hereinafter distributing device), primarily for hydraulically driven pump-injectors of internal combustion engines, specifically for diesels, comprises:
A body with inlet and outlet channels for the connection with a source of actuating fluid (accumulator or rail), which in turn is connected to the actuating fluid pump, and a drain tank or sump, respectively, said body also comprising a channel connecting the distribution device with pressure intensifier consisting of a pumping plunger and power piston, a working cavity being formed above the piston and connected via said channel and said distribution device with the accumulator of the actuating fluid;
Two control stages for regulating the distribution of the actuating fluid, the first stage that controls the operation of the second stage and is disposed in the body comprising a slide, conical or spherical valve, predominantly having an electromagnetic drive controlled by an electronic control unit (the first stage valve can also be controlled by piezoelectric, magnetostriction, mechanical or other devices), and the second stage, also disposed in the body, designed for distributing the actuating fluid near the power piston of the pressure intensifier, comprising a slide, conical or spherical valve driven by pushrods whose diameter is smaller than that of the valve, said valve being in reciprocating motion moved by said pushrods.

2. Distribution device as in claim 1, wherein the conical or spherical two-way valve of the first stage of the distribution device has main and tail sections divided by a cylindrical protrusion on which two sealing conical or spherical surfaces are located concentrically with the valve axis and facing each other, one of said surfaces, moved by the valve spring, being pressed against the sealing annular seat formed in said body concentrically with the axis of the cylindrical orifice in which the main section of the valve is moving that has a precision connection with said orifice, said main section of the valve having a cylindrical groove in the area adjacent to said protrusion that is constantly connected via the channel formed in the body with the source of the actuating fluid; second sealing surface of the protrusion facing the tail section of the valve when the electromagnet is energized is set against a sealing annular seat formed concentrically with the orifice of the bushing mounted in said body, the internal orifice of the bushing embracing the tail section of the valve and forming a precision connection with it; said bushing is centered with the tail section of the valve and is freely mounted in the body with regard to its external surface, bores or grooves being disposed along the tail section of the valve connected with the circular groove formed on the tail section of the valve in the area adjacent to the protrusion of the valve; an annular distributing cavity is formed in said body embracing the valve in the area of said protrusion and is constantly connected via channel formed in the body with the pushrod of the second stage, in the open valve position said cavity is displaced by the electromagnet and is periodically connected with the source of the actuating fluid or, in the closed valve position, moved by the spring, it is connected via said annular groove and channels on the tail section of the valve with the drain tank.

3. Distribution device as in claim 1, wherein the conical or spherical two-way valve of the second stage of the distribution device has main and tail sections divided by a cylindrical protrusion on which sealing conical or spherical surfaces are located concentrically with the valve axis and facing each other, one of these surfaces in the closed valve position being pressed against sealing annular seat formed in said body concentrically with the axis of the cylindrical orifice in which the main section of the valve is moving that has a precision connection with said orifice, said main section of the valve in the area adjacent to said protrusion having a cylindrical groove, constantly connected via a channel formed in the body with a source of the actuating fluid; said second sealing surface of the protrusion facing the tail section of the valve, in its open position is set against sealing annular bearing edge formed concentrically with the orifice of the bushing mounted in said body, the internal orifice of said bushing embracing the tail section of the valve and forming a precision connection with the valve, said bushing being centered with the tail section of the valve and being freely mounted in the body with regard to its external surface, while along the tail section of the valve bores or grooves are disposed, connected with the annular groove formed on the tail section of the valve in the area adjacent to the protrusion of the valve, and connected via the channel formed in the body with the drain tank; in said body, annular distributing cavity is formed embracing the valve in the area of said protrusion, which is constantly connected with the working cavity of the power piston of the pressure intensifier of hydraulically driven pump-injector (or with another actuating mechanism of cyclic action) via channels, formed in said bushing along its axis and periodically connected with said groove in the main section of the valve in the open valve position, or via said groove and bores in the tail section of the valve and channels formed in the body, is connected with the drain tank.

4. Distribution device as in claim 2 and 3, wherein the diameters of sealing annular seats of the bodies of the first and second stages and diameters of the sealing annular seats of the bushings embracing the tail sections of the valves for the first and for the second stage respectively, are equal to each other, and equivalent to the diameters of the main and tail sections of the valves of the first and second stages, respectively.

5. Distribution device as in claim 2, wherein said tail section of the first stage valve on the side of the end adjoining the electromagnet, has an extension in the form of a disk adjoining the electromagnet serving as an armature of the electromagnetic drive and being manufactured of a material with high magnetic permeability (for instance, of low-carbon steel), possibly as an autonomous component fixed to the tail section of the valve, for instance by a thread joint, main and tail sections of the valve being manufactured of high-carbon highly durable alloyed steel.

6. Distribution device as in claim 1 and 3, wherein said pushrods transferring reciprocating motion to the second stage valve, have different diameters (the larger-diameter pushrod performs a working stroke, and the smaller-diameter pushrod performs a return stroke) and are disposed coaxially with the axis of the valve, one of the pushrods' ends contacting the valve, while near the pushrods' ends adjoining the valve, drain cavities are formed in the body, connected by channels with the drain tank, and near the opposite pushrods' ends, working cavities are formed in the body, one of said working cavities near the smaller-diameter pushrod being constantly connected via channel and a jet with the source of the actuating fluid, and another said working cavity near the end of the larger-diameter pushrod is connected via said channel with said distributing cavity of the first stage.

7. Distribution device as in claims 1 and 3, wherein in the body of the second stage instead of the smaller-diameter pushrod a spring is installed that contacts the second stage valve and causes the valve to perform the return stroke.

8. Distribution device as in claims 1, 3 and 6, wherein a groove is made on the larger-diameter pushrod, said groove being connected by axial and radial channels with said drain cavity of the larger-diameter pushrod, said channels having a jet, the groove being disposed in such a way that in the initial phase of the working stroke of the pushrod with the valve, the groove is connected with said working cavity of the larger-diameter pushrod.

9. Distribution device as in claim 1, 2, 3, wherein the first and second stages of the distribution device are made as independent units communicating with one another by a channel and having separate bodies, or they are disposed in a single body comprising both stages.

10. Distribution device as in claim 1, 2, 3, wherein each of the valves of the first or second stage of the distribution device or both valves are disposed directly in the body of the pump-injector, and form a precision connection with the pump-injector body.
